(19) United States
(12) Patent Application Publication
(10) Pub. No.: US 2015/0120773 A1
(43) Pub. Date: Apr. 30, 2015

(54) INFREQUENT QUERY VARIANTS FOR USE AS QUERY SUGGESTIONS

(71) Applicant: Lev Finkelstein, Netanya (IL)

(72) Inventor: Lev Finkelstein, Netanya (IL)

(73) Assignee: Google Inc., Mountain View, CA (US)

(21) Appl. No.: 13/282,343

(22) Filed: Oct. 26, 2011

(51) Int. Cl. G06F 17/30

(52) U.S. Cl. CPC G06F 17/3097
USPC 707/767; 707/E17.137

(57) ABSTRACT

The technology described identifies infrequently submitted past queries for use as query suggestions that are likely assist users in finding the information they seek. The technology includes filtering of infrequent queries by comparing canonical representations of the infrequent queries to canonical representations of popular queries. Canonical representations of infrequent queries are matched to canonical representations of popular queries; any infrequent queries are rejected from use as suggested queries if their canonical representation does not match that of any popular query. Selected infrequent queries can be stored as authorized for use by a subsequent computerized process in determining a query suggestion.

### BACKGROUND

The present disclosure relates to query processing. In particular, it relates to identifying search query suggestions.

Information retrieval systems, especially Internet search engines, help users by retrieving information, such as web pages, images, text documents and multimedia content, in response to queries. Search engines use a variety of signals to determine the relevance of the retrieved content to the user's query.

Formulating a query that accurately represents the user's informational need can be challenging. Search engines may suggest queries to the user, to help the user. Some search engines provide query suggestions to the user as the user is typing a query, essentially completing the query by typing ahead for the user.

The queries suggested by the search engine often are taken from past user queries. However, it can be difficult to evaluate the usefulness of a past query as a query suggestion. In particular, due to the sparse nature of infrequent queries, it can be difficult to identify the infrequent queries that are likely to assist users in finding the information they seek. As a result, a user formulating an uncommon query may not be provided with any suggestions, or may be provided with suggestions that are unrelated to the user's informational need. This can frustrate the user and result in a poor user experience.

### SUMMARY

In one implementation, a method of processing a log of past queries submitted by a plurality of users is described. The method includes identifying one or more infrequent queries in the log. An infrequent query is a query in the log that has been submitted less than a first threshold number of times. The method also includes reformulating each of the identified infrequent queries into respective canonical representations using canonicalization rules. The method also includes selecting one or more of the identified infrequent queries which have canonical representations matching that of at least one popular query in the log. A popular query is a query in the log that has been submitted at least a second threshold number of times. The method also includes storing data identifying the selected one or more infrequent queries as being permitted for use in determining a query suggestion.

This method and other implementations of the technology disclosed can each optionally include one or more of the following features. The method can further include storing data associating the selected uncommon queries with the popular queries.

The method can further include rejecting identified infrequent queries which have canonical representations which do not match that of at least one popular query in the log.

The method can further include where the first threshold number is equal to the second threshold number. The method can further include where the second threshold number is greater than the first threshold number.

The method can further include where the canonicalization rules include stemming of terms in the identified infrequent queries. The method can further include where the canonicalization rules include arranging canonical forms of terms in the identified infrequent queries in a sequence based on a predefined order.

The method can further include identifying a set of infrequent queries in the log which have the same canonical representation. A determination can then be made that a sum of occurrences in the log of the infrequent queries in the set exceeds a third threshold number. In response to the determination, data can then stored identifying the infrequent queries in the set as being permitted for use in determining a query suggestion.

The method can further include where the third threshold number is equal to the second threshold number.

The method can further include receiving a query. One or more of the permitted infrequent queries can then be selected as query suggestions for the received query. The selected one or more permitted infrequent queries can then be sent in response to receiving the query.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Particular implementations of the subject matter described herein can identify infrequently submitted past queries for use as query suggestions that are likely to assist users in finding the information they seek. These infrequent queries can provide meaningful suggested queries to users who formulate an uncommon query.

Particular aspects of one or more implementations of the subject matter described in this specification are set forth in the drawings and the description below. Other features, aspects, and advantages of the subject matter will become apparent from the description, the drawings, and the claims.

### BRIEF DESCRIPTION OF THE DRAWINGS

FIG. 1 illustrates a block diagram of an example environment in which selecting infrequent queries suitable for use as query suggestions can be used.

FIG. 2 is a block diagram illustrating example modules within the infrequent query selection engine.

FIG. 3 is a flow chart illustrating an example process for selecting infrequent queries suitable for use as query suggestions.

FIG. 4 illustrates an example of queries and their corresponding canonical representations.

FIG. 5 is a flow chart illustrating an example process for providing a permitted infrequent query as a query suggestion.

FIG. 6 is a screenshot illustrating an example environment that can be used to provide infrequent queries as query suggestions to a user.

FIG. 7 is a block diagram of an example computer system.

### DETAILED DESCRIPTION

The technology described identifies infrequently submitted past queries for use as query suggestions that are likely assist users in finding the information they seek. The technology includes filtering of infrequent queries by comparing canonical representations of the infrequent queries to canonical representations of popular queries. The canonical representations are generated using a set of canonicalization rules that enable matching of infrequent and popular queries that have different formulations, but which represent the same or similar information request.

Canonical representations of infrequent queries are matched to canonical representations of popular queries; any infrequent queries are rejected from use as suggested queries if their canonical representation does not match that of any popular query. The use of the canonicalization rules enables the identification of infrequent queries that are likely to be meaningful query suggestions, but would otherwise be too sparse to reliably identify.

Selected infrequent queries can be stored as authorized for use by a subsequent computerized process in determining a query suggestion. For example, the subsequent computer process may choose one or more of the selected infrequent queries to be a query suggestion or autocompletion for a user. The identified infrequent queries allows additional query suggestions to be provided, which increases the likelihood of providing query suggestions that will assist users in finding the information they seek. In doing so, meaningful query suggestions can be provided to users who formulate an uncommon query.

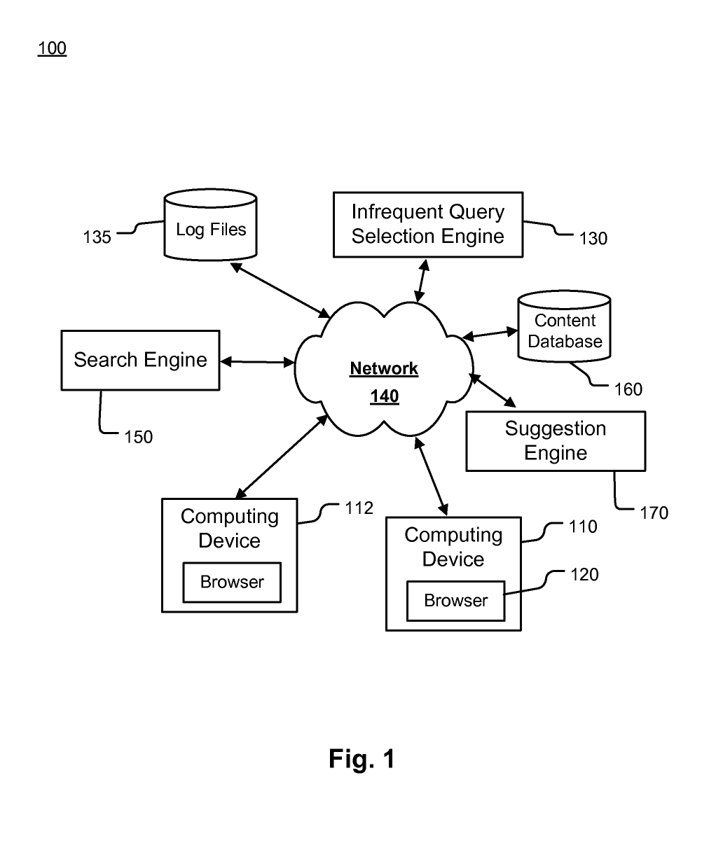

FIG. 1 illustrates a block diagram of an example environment 100 in which selecting infrequent queries suitable for use as query suggestions can be used. The environment 100 includes client computing devices 110, 112 and a search engine 150. The environment also includes a communication network 140 that allows for communication between various components of the environment 100.

During operation, users interact with the search engine 150 through the client computing devices 110, 112. The client computing devices 110, 112 and the search engine 150 each include memory for storage of data and software applications, a processor for accessing data and executing applications, and components that facilitate communication over the communication network 140. The computing devices 110, 112 execute applications, such as web browsers (e.g. web browser 120 executing on computing device 110), that allow users to formulate queries and submit them to the search engine 150. The search engine 150 receives queries from the computing devices 110, 112, and executes the queries against a content database 160 of available resources such as web pages, images, text documents and multimedia content. The search engine 150 identifies content which matches the queries, and responds by generating search results which are transmitted to the computing devices 110, 112 in a form that can be presented to the users. For example, in response to a query from the computing device 110, the search engine 150 may transmit a search results web page to be displayed in the web browser 120 executing on the computing device 110.

The search engine 150 maintains log files 135 of user session query data associated with past queries received from users. The log files 135 may be collectively stored on one or more computers and/or storage devices. The log files 135 may include unique identifiers, such as unique cookie identifiers, associated with the users who submitted the past queries. The unique identifiers do not include personal information of the users. As described in more detail below, the unique identifiers can be used to determine the number of unique users who have submitted a given query.

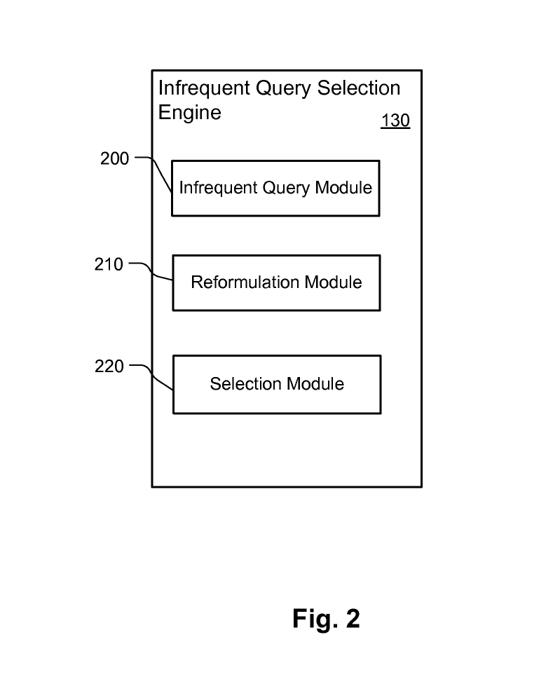

The environment 100 also includes an infrequent query selection engine 130. The log files 135 are processed by the infrequent query selection engine 130 to select infrequent queries that are suitable for use as query suggestions using the techniques described herein. The infrequent query selection engine 130 can be implemented in hardware, firmware, or software running on hardware. The infrequent query selection engine 130 is described in more detail below with reference to FIGS. 2-6.

In response to a user's query, the search engine 150 may forward the user's query to a suggestion engine 170. The suggestion engine 170 includes memory for storage of data and software applications, a processor for accessing data and executing applications, and components that facilitate communication over the communication network 140. The suggestion engine 170 may use conventional or other techniques to select one or more of the selected infrequent queries as query suggestions for the user's query. The suggestion engine 170 can then provide these query suggestions to the user.

These query suggestions provided by the suggestion engine 170 represent queries that the users may want to submit in addition to, or instead of, the queries actually typed or submitted. The query suggestions may, for example, be embedded within a search results web page to be displayed in an application, such as a web browser, executing on the user's computing device. As another example, the query suggestions may be displayed within a cascaded drop down menu of the search field of an application, such as a web browser, executing on the user's computing device as the user is typing the query. In some implementations, search results for a query suggestion within the cascaded drop down menu are also displayed as the user is typing the query.

The network 140 facilitates communication between the various components in the environment 100. In one implementation, the network 140 includes the Internet. The network 140 can also utilize dedicated or private communication links that are not necessarily part of the Internet. In one implementation, the network 140 uses standard communications technologies, protocols, and/or inter-process communication techniques.

FIG. 2 is a block diagram illustrating example modules within the infrequent query selection engine 130. In FIG. 2, the infrequent query selection engine 130 includes an infrequent query module 200, a reformulation module 210 and a selection module 220. Some implementations may have different and/or additional modules than those shown in FIG. 2. Moreover, the functionalities can be distributed among the modules in a different manner than described herein.

The infrequent query module 200 analyzes the log files 135 to identify infrequent past queries and popular past queries that have been submitted by users. An infrequent query in the log files 135 is a query which has been submitted less than a first threshold number. In some implementations, a given query is an infrequent query if it occurs in the log files 135 a total number of times that is less than the first threshold number. In other implementations, the given query is an infrequent query if it has been submitted by a number of unique users that this less than the first threshold number. A unique user is a user associated with a particular unique identifier. The number of unique users who have submitted a given query may be determined based on the number of unique cookie identifiers in the log files 135 that are associated with the given query.

A popular query in the log files 135 is a query which has been submitted at least a second threshold number. In some implementations, the first threshold number is equal to the second threshold number. Alternatively the second threshold number may be greater than the first threshold number.

A variety of different techniques can be used to determine the threshold numbers. For example, the threshold numbers may be manually selected constants. As another example, the threshold numbers may be determined based on statistical information such as the confidence level. In other words, the popular and infrequent queries are filtered by selecting those having confidence levels that exceed predetermined confidence thresholds. As yet another example, the threshold numbers may be determined based on resource constraints such as a limited memory. In some implementations, the amount of available memory is used to limit the maximum number of popular queries and the maximum number of infrequent queries that will be selected.

The reformulation module 210 reformulates the infrequent queries and the popular queries into respective canonical representations using a set of canonicalization rules. The canonicalization rules enable matching of infrequent and popular queries that have different formulations, but which represent the same or similar user information request. The canonicalization rules can vary from implementation to implementation.

Canonicalization can include the process of converting the terms in a query into a standard form by replacing the terms with their canonical forms when the terms meet certain criteria. With canonicalization, an infrequent query and a popular query that represent the same or similar information request can be matched, so that infrequent queries that can be meaningful query suggestions can be identified.

In some implementations, the canonicalization rules include stemming of terms in the queries. Stemming is the process of reducing various grammatical forms of a term to a common root form. Stemming can include the removal and/or replacement of characters in the term. For example, stemming can include replacing plural nouns with corresponding singular nouns.

In some implementations, the canonicalization rules include the removal of terms in the identified infrequent queries which are stop words. Stop words include words that are common. The stop words can include articles such as “a,” “and,” and “the.” The stop words can include conjunctions such as “or,” “and,” and “nor.” The stop words can also include prepositions such as “of” and “to.”

In some implementations, the canonicalization rules include arranging canonical forms of terms in the queries based on a predefined order. For example, the canonical forms of terms in the queries may be arranged in alphabetical order. Identical terms in a given query may also be removed in some implementations. The canonicalization rules may also include punctuation removal, lowercasing, removal of diacriticals, and URL normalization. Other canonicalization rules can also be used.

The selection module 220 then compares the canonical representations of the infrequent queries to the canonical representations of the popular queries. The selection module 220 then selects infrequent queries which have canonical representations matching that of at least one popular query. The selection module 220 may select the infrequent queries using a join-type operation between the canonical representations of the infrequent queries and the canonical representations of the frequent queries.

In some implementations, the matching is carried out by exact matching of the canonical representation strings. In other implementations, this matching can be carried out by comparing the strings using soft matching. The soft matching may for example be carried out by calculating an edit distance of the strings and comparing that to a threshold.

The selection module 220 also rejects infrequent queries which have canonical representations which do not match that of at least one popular query.

The selection module 220 then stores data identifying the selected infrequent queries as being permitted for use in determining a query suggestion. This data may, for example, be stored in the form of a query list or another type of data structure maintained by the selection module 220. This data can then be used by the suggestion engine 170 to provide meaningful infrequent queries as query suggestions to users.

The selection module 220 may also identify a set of infrequent queries which have the same canonical representation. In some implementations, the infrequent queries in the set are identified using exact matching techniques of their corresponding canonical representations. In other implementations, soft matching techniques may be used.

The selection module 220 sums the occurrences in the log files 135 of the infrequent queries across the set. If the sum exceeds a third threshold number, the selection module 220 stores data identifying the infrequent queries in the set as being permitted for use in determining a query suggestion. The use of the sum of the occurrences allows for the identification of a set of infrequent queries that represent the same or similar information request, but which individually would be too sparse to reliably identify. The third threshold number may for example be equal to the second threshold number that is used to identify popular queries.

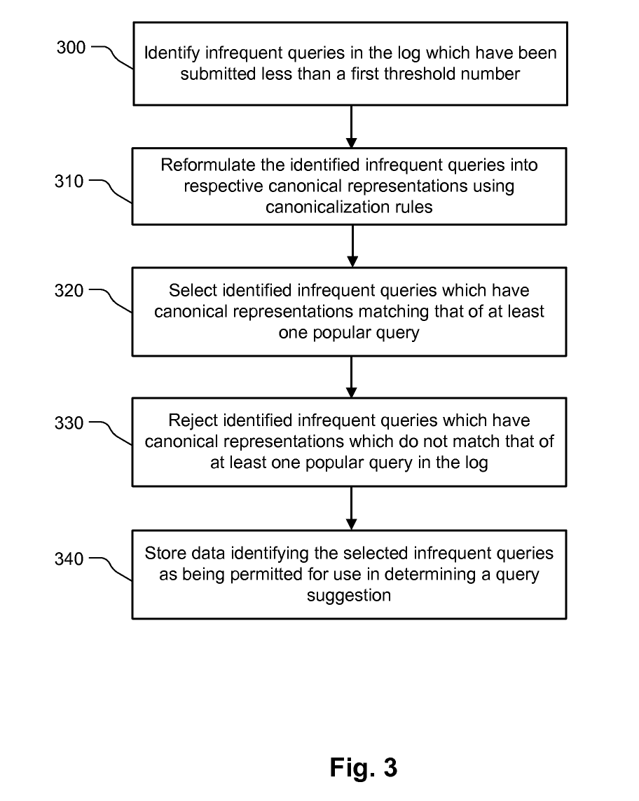

FIG. 3 is a flow chart illustrating an example process for selecting infrequent queries for use as query suggestions. Other embodiments may perform the steps in different orders and/or perform different or additional steps than the ones illustrated in FIG. 3. For convenience, FIG. 3 will be described with reference to a system of one or more computers that performs the process. The system can be, for example, the infrequent query selection engine 130 described above with reference to FIG. 1.

At step 300, the system identifies infrequent queries in the log files 135 which have been submitted less than a first threshold number. The system also identifies the popular queries in the log files 135 which have been submitted at least a second threshold number.

At step 310, the system reformulates the identified infrequent queries into respective canonical representations using canonicalization rules. The system also reformulates the identified popular queries into respective canonical representations using the canonicalization rules.

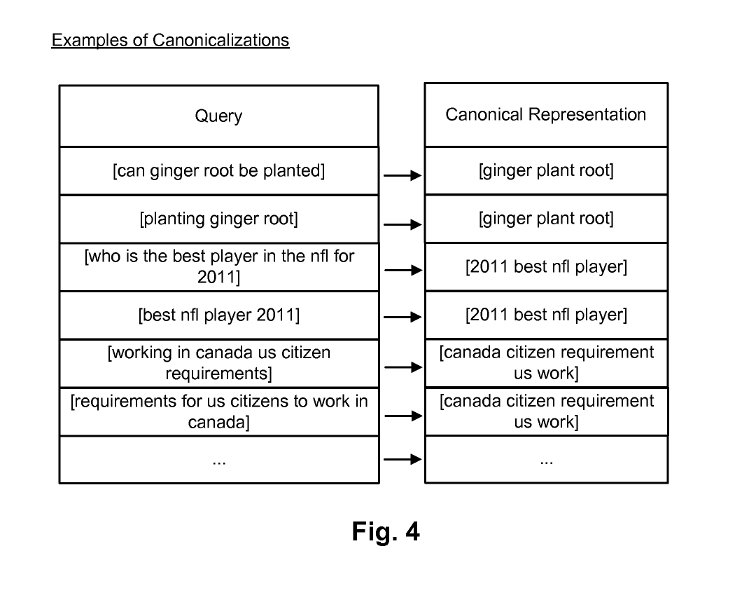

FIG. 4 illustrates an example of queries and their canonical representation. In this example, the query “can ginger root be planted” is an infrequent query, and the query “planting ginger root” is a popular query. In this example, the canonical rules include the removal of stop words such as “can” and “be,” stemming and the alphabetical reordering of the canonical forms of the remaining terms. As shown in FIG. 4, the infrequent query “can ginger root be planted” and the popular query “planting ginger root” have the same canonical representation, “ginger plant root.” Similarly, the infrequent query “who is the best player in the nfl for 2011” and the popular query “best nfl player 2011” have the same canonical representation, “2011 best nfl player”. The infrequent query “working in canada us citizen requirements” and the popular query “requirements for us citizens to work in canada” have the same canonical representation, “canada citizen requirement us work”.

Returning to FIG. 3, at step 320 the system selects identified infrequent queries which have canonical representations matching that of at least one popular query. Thus, in the example of FIG. 4, the infrequent queries “can ginger root be planted”, “who is the best player in the nfl for 2011”, and “working in canada us citizen requirements” will be selected.

At step 330, the system rejects identified infrequent queries which have canonical representations which do not match that of at least one popular query in the log. At step 340, the system stores data identifying the selected infrequent queries as being permitted for use in determining a query suggestion. The system may also store data associating the selected infrequent queries with the corresponding popular queries.

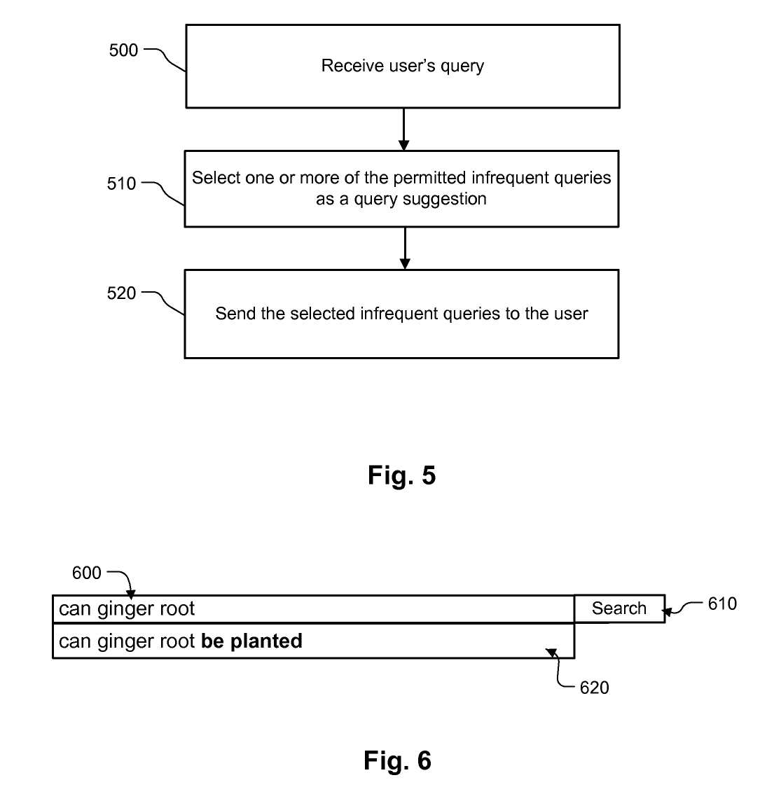

FIG. 5 is a flow chart illustrating an example process for providing a permitted infrequent query as a query suggestion. Other embodiments may perform the steps in different orders and/or perform different or additional steps than the ones illustrated in FIG. 5. For convenience, FIG. 5 will be described with reference to a system of one or more computers that performs the process. The system can be, for example, the suggestion engine 170 described above with reference to FIG. 1.

At step 500, the system receives a user's query. At step 510, the system selects one or more of the permitted infrequent queries as a query suggestion for the user's query. This selection can be performed by inspecting the query list or other data structure identifying the permitted infrequent queries. The system may then match the user's query to one or more of the permitted infrequent queries to select query suggestions for the user's query. The system may use conventional or other techniques to determine one or more of the permitted infrequent queries that are appropriate query suggestions for the user's query. For example, the system may use prefix based matching.

At step 520, the system sends the selected infrequent queries as query suggestions to the user.

FIG. 6 is a partial screen shot illustrating an example environment that can be used to provide infrequent queries as meaningful query suggestions to a user. In FIG. 6, the partial screen shot includes a search field representation 600 and a search button representation 610. In this example, while the user is entering the query “can ginger root” into the search field representation 600, a cascaded drop down menu 620 of the search field is displayed. In this example, the drop down menu 620 includes the infrequent query “can ginger root be planted” as a query suggestion.

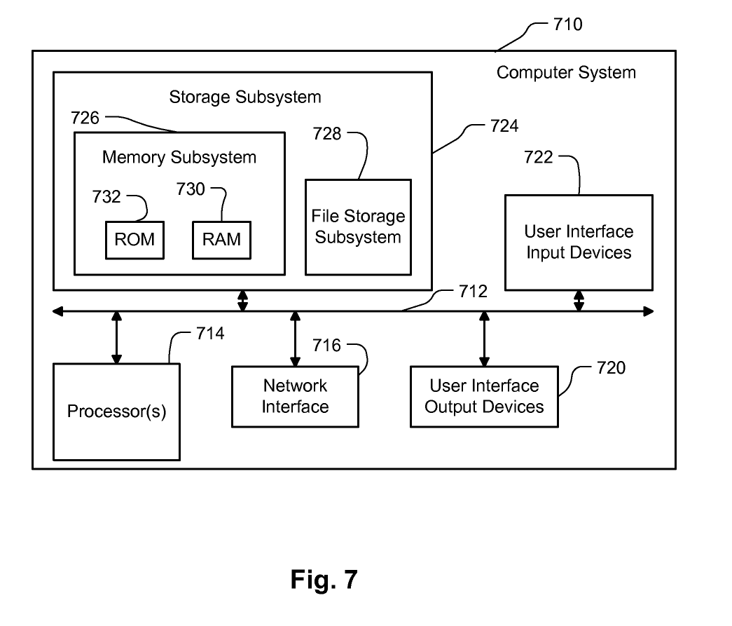

FIG. 7 is a block diagram of an example computer system. Computer system 710 typically includes at least one processor 714 which communicates with a number of peripheral devices via bus subsystem 712. These peripheral devices may include a storage subsystem 724, comprising for example memory devices and a file storage subsystem, user interface input devices 722, user interface output devices 720, and a network interface subsystem 716. The input and output devices allow user interaction with computer system 710. Network interface subsystem 716 provides an interface to outside networks, including an interface to communication network 140, and is coupled via communication network 140 to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into computer system 710 or onto communication network 140.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein, including the logic to select infrequent queries for use as query suggestions according to the processes described herein. These software modules are generally executed by processor 714 alone or in combination with other processors.

Memory 726 used in the storage subsystem can include a number of memories including a main random access memory (RAM) 730 for storage of instructions and data during program execution and a read only memory (ROM) 732 in which fixed instructions are stored. A file storage subsystem 728 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 728 in the storage subsystem 724, or in other machines accessible by the processor.

Bus subsystem 712 provides a mechanism for letting the various components and subsystems of computer system 710 communicate with each other as intended. Although bus subsystem 712 is shown schematically as a single bus, alternative embodiments of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating the preferred embodiments. Many other configurations of computer system 710 are possible having more or fewer components than the computer system depicted in FIG. 7.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for selecting infrequent queries for use as query suggestions, systems including logic and resources to select infrequent queries for use as query suggestions, systems that take advantage of computer-assisted methods for selecting infrequent queries for use as query suggestions, media impressed with logic to select infrequent queries for use as query suggestions, data streams impressed with logic to select infrequent queries for use as query suggestions, or computer-accessible services that carry out computer-assisted methods for selecting infrequent queries for use as query suggestions. It is contemplated that modifications and combinations will readily occur to those skilled in the art, which modifications and combinations will be within the scope of the following claims.

We claim as follows:

1. A method of processing a log of past queries submitted by a plurality of users, the method comprising:
identifying one or more infrequent queries in the log, wherein an infrequent query is a query in the log that has been submitted less than a first threshold number of times;
reformulating each of the identified infrequent queries into respective canonical representations using canonicalization rules;
identifying one or more of the identified infrequent queries which have canonical representations matching that of at least one popular query in the log based on comparing the canonical representations of the identified infrequent queries to that of the at least one popular query, wherein a popular query is a query in the log that has been submitted at least a second threshold number of times;
selecting one or more of the identified infrequent queries based at least in part on identifying the selected one or more of the identified infrequent queries as having canonical representations matching that of at least one popular query in the log; and
storing data identifying the selected one or more infrequent queries as being permitted for use in determining a query suggestion.

2. The method of claim 1, further comprising storing data associating the selected infrequent queries with corresponding popular queries.

3. The method of claim 1, further comprising:
identifying a set of one or more of the identified infrequent queries which have canonical representations which do not match that of at least one popular query in the log; and
rejecting the identified infrequent queries of the set for use in determining a query suggestion in response to future queries.

4. The method of claim 1, wherein the first threshold number is equal to the second threshold number.

5. The method of claim 1, wherein the second threshold number is greater than the first threshold number.

6. The method of claim 1, wherein the canonicalization rules include stemming of terms in the identified infrequent queries.

7. The method of claim 1, wherein the canonicalization rules include arranging canonical forms of terms in the identified infrequent queries based on a predefined order.

8. The method of claim 1, further comprising:
identifying a set of infrequent queries in the log which have the same canonical representation;
determining that a sum of occurrences in the log of the infrequent queries in the set exceeds a third threshold number; and
in response to the determination, storing data identifying the infrequent queries in the set as being permitted for use in determining a query suggestion.

9. The method of claim 8, wherein the third threshold number is equal to the second threshold number.

10. The method of claim 1, further comprising:
receiving a query;
selecting one or more of the permitted infrequent queries as query suggestions for the received query; and
sending the selected one or more permitted infrequent queries in response to receiving the query.

11. A non-transitory computer readable storage medium storing computer instructions executable by a processor to perform a method of processing a log of past queries submitted by a plurality of users, the method comprising:
identifying one or more infrequent queries in the log, wherein an infrequent query is a query in the log that has been submitted less than a first threshold number of times;
reformulating each of the identified infrequent queries into respective canonical representations using canonicalization rules;
identifying one or more of the identified infrequent queries which have canonical representations matching that of at least one popular query in the log based on comparing the canonical representations of the identified infrequent queries to that of the at least one popular query, wherein a popular query is a query in the log that has been submitted at least a second threshold number of times;
selecting one or more of the identified infrequent queries based at least in part on identifying the selected one or more of the identified infrequent queries as having canonical representations matching that of at least one popular query in the log; and
storing data identifying the selected one or more infrequent queries as being permitted for use in determining a query suggestion.

12. The non-transitory computer readable storage medium of claim 11, further comprising storing data associating the selected infrequent queries with corresponding popular queries

13. The non-transitory computer readable storage medium of claim 11, further comprising:
identifying a set of one or more of the identified infrequent queries which have canonical representations which do not match that of at least one popular query in the log; and
rejecting the identified infrequent queries of the set for use in determining a query suggestion in response to future queries.

14. The non-transitory computer readable storage medium of claim 11, wherein the first threshold number is equal to the second threshold number.

15. The non-transitory computer readable storage medium of claim 11, wherein the second threshold number is greater than the first threshold number.

16. The non-transitory computer readable storage medium of claim 11, wherein the canonicalization rules include stemming of terms in the identified infrequent queries.

17. The non-transitory computer readable storage medium of claim 11, wherein the canonicalization rules include arranging canonical forms of terms in the identified infrequent queries based on a predefined order.

18. The non-transitory computer readable storage medium of claim 11, further comprising:
identifying a set of infrequent queries in the log which have the same canonical representation;
determining that a sum of occurrences in the log of the infrequent queries in the set exceeds a third threshold number; and
in response to the determination, storing data identifying the infrequent queries in the set as being permitted for use in determining a query suggestion.

19. The non-transitory computer readable storage medium of claim 18, wherein the third threshold number is equal to the second threshold number.

20. The non-transitory computer readable storage medium of claim 11, further comprising:
receiving a query;
selecting one or more of the permitted infrequent queries as query suggestions for the received query; and
sending the selected one or more permitted infrequent queries in response to receiving the query.

21. A system including memory and one or more processors operable to execute instructions, stored in the memory, to process a log of past queries submitted by a plurality of users, comprising instructions to:
identify one or more infrequent queries in the log, wherein an infrequent query is a query in the log that has been submitted less than a first threshold number of times;
reformulate each of the identified infrequent queries into respective canonical representations using canonicalization rules;
identify one or more of the identified infrequent queries which have canonical representations matching that of at least one popular query in the log based on comparing the canonical representations of the identified infrequent queries to that of the at least one popular query, wherein a popular query is a query in the log that has been submitted at least a second threshold number of times;
select one or more of the identified infrequent queries based at least in part on identifying the selected one or more of the identified infrequent queries as having canonical representations matching that of at least one popular query in the log; and
store data identifying the selected one or more infrequent queries as being permitted for use in determining a query suggestion.

22. The system of claim 21, further comprising instructions to store data associating the selected infrequent queries with corresponding popular queries.

23. The system of claim 21, further comprising instructions to:
identify a set of one or more of the infrequent queries which have canonical representations which do not match that of at least one popular query in the log; and
reject the identified infrequent queries of the set for use in determining a query suggestion in response to future queries

24. The system of claim 21, wherein the first threshold number is equal to the second threshold number.

25. The system of claim 21, wherein the second threshold number is greater than the first threshold number.

26. The system of claim 21, wherein the canonicalization rules include stemming of terms in the identified infrequent queries.

27. The system of claim 21, wherein the canonicalization rules include arranging canonical forms of terms in the identified infrequent queries based on a predefined order.

28. The system of claim 21, further comprising instructions to:
identify a set of infrequent queries in the log which have the same canonical representation;
determine that a sum of occurrences in the log of the infrequent queries in the set exceeds a third threshold number; and
in response to the determination, store data identifying the infrequent queries in the set as being permitted for use in determining a query suggestion.

29. The system of claim 28, wherein the third threshold number is equal to the second threshold number.

30. The system of claim 21, further comprising instructions to:
receive a query;
select one or more of the permitted infrequent queries as query suggestions for the received query; and
sending the selected one or more permitted infrequent queries in response to receiving the query.
